(19) United States
(12) Patent Application Publication
(10) Pub. No.: US 2026/0287178 A1
(43) Pub. Date: Sep. 24, 2026

(54) CROSS FIRE TUBE INSTALLATION/REMOVAL METHODS AND APPARATUS

(71) Applicant: GE Vernova Infrastructure Technology LLC, Greenville, SC (US)

(72) Inventors: Piotr DZIECIOL, Warszawa (PL); Mateusz DOLECKI, Warszawa (PL); Piotr WOJCIECHOWSKI, Warszawa (PL); Szymon PERKOWSKI, Warszawa (PL); Marek SZYSZKOWSKI, Warszawa (PL)

(21) Appl. No.: 19/694,465

(22) Filed: Jun. 1, 2026

Related U.S. Application Data
(63) Continuation of application No. 16/890,142, filed on Jun. 2, 2020, now Pat. No. 12,669,246.

(30) Foreign Application Priority Data
Jun. 13, 2019 (PL) P.430232

(51) Int. Cl. F23R 3/48

(52) U.S. Cl. CPC F23R 3/48; F05D 2230/60; F05D 2240/35

(57) ABSTRACT

The present application provides a cross fire tube installation/removal apparatus for use with a combustor of a gas turbine engine. The cross fire tube installation/removal apparatus includes a cross fire tube assembly having a sleeve with a tube groove therein and a cross fire tube tool having a spring with a spring flange. The spring flange is sized to engage the tube groove.

### TECHNICAL FIELD

The present application and the resultant patent relate generally to gas turbine engines and more particularly relate to improved methods and apparatus for the installation and removal of gas turbine combustor cross fire tubes in a fast, safe, and efficient manner.

### BACKGROUND OF THE INVENTION

Adjacent combustors of a gas turbine engine are typically connected by a cross fire tube. Specifically, a cross fire tube may extend through the liners, the flow sleeves, and the casings of adjacent combustors to allow the combustion in one combustor to propagate to the adjacent combustor and to ensure substantially simultaneous ignition and equalized pressure in all combustor chambers of the gas turbine engine. Generally described, the cross fire tubes need to be removed prior to combustor removal and the like. The assembly and/or the location of the cross fire tubes, however, may have one or more disadvantages. For example, current installation and removal methods may be complicated and may result in damage to the cross fire tubes and related components.

### SUMMARY OF THE INVENTION

The present application and the resultant patent thus provide a cross fire tube installation/removal apparatus for use with a combustor of a gas turbine engine. The cross fire tube installation/removal apparatus includes a cross fire tube assembly having a sleeve with a tube groove therein and a cross fire tube tool having a spring with a spring flange. The spring flange is sized to engage the tube groove.

The present application and the resultant patent further provide a method of installing a cross fire tube assembly between a first combustor can and a second combustor can. The method includes the steps of inserting a cross fire tube tool through a first passage in the first combustor can, engaging a groove in the cross fire tube assembly with a spring flange of the cross fire tube tool, compressing the cross fire tube tool with the cross fire tube assembly engaged, positioning the cross fire tube assembly in a second passage in the second combustor can, and releasing the cross fire tube tool.

The present application and the resultant patent further provide a cross fire tube installation/removal apparatus for use with a combustor of a gas turbine engine. The cross fire tube installation/removal apparatus includes a cross fire tube assembly having a pair of sleeves with a bias and with each sleeve having a tube groove therein and a cross fire tube tool having a tubular spring with a spring flange. The spring flange is sized to engage the tube groove.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, a combustor, a turbine, and a load.

FIG. 2 is a schematic diagram of an example combustor.

FIG. 3 is a side sectional view of an exemplary cross fire tube installation/removal apparatus as may be described herein with a cross fire tube assembly positioned between adjacent combustor cans.

FIG. 4 is a perspective of the cross fire tube installation/removal apparatus of FIG. 3.

FIG. 5 is a side view of the cross fire tube installation/removal apparatus of FIG. 3.

FIG. 6 is a cross-sectional view of the cross fire tube installation/removal apparatus of FIG. 3 taken along line 6-6 of FIG. 5.

FIG. 7 is a cross-sectional view of the cross fire tube installation/removal apparatus of FIG. 3 taken along line 7-7 of FIG. 5.

FIG. 8 is a side view of the cross fire tube installation/removal apparatus in use with a cross fire tube assembly positioned between adjacent combustor cans.

FIG. 9 is a side view of the cross fire tube installation/removal apparatus in further use with a cross fire tube assembly positioned between adjacent combustor cans.

FIG. 10 is a side view of the cross fire tube installation/removal apparatus in further use with a cross fire tube assembly positioned between adjacent combustor cans.

FIG. 11 is a side view of the cross fire tube installation/removal apparatus in further use with a cross fire tube assembly positioned between adjacent combustor cans.

### DETAILED DESCRIPTION

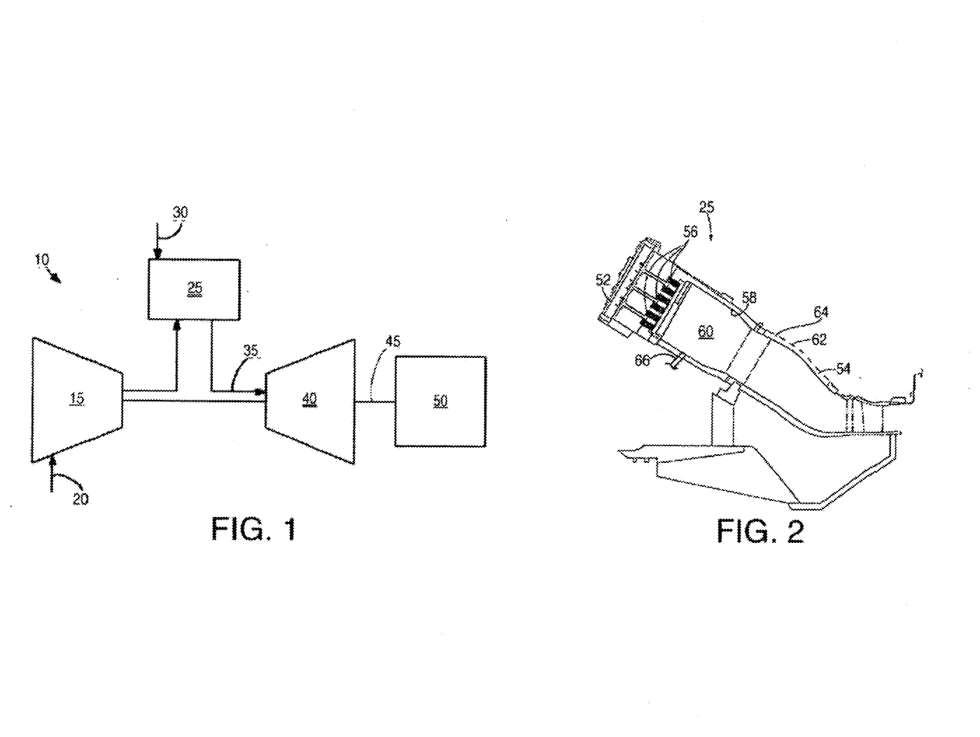

Referring now to the drawings, in which like numerals refer to like elements throughout the several views, FIG. 1 shows a schematic diagram of gas turbine engine 10 as may be used herein. The gas turbine engine 10 may include a compressor 15. The compressor 15 compresses an incoming flow of air 20. The compressor 15 delivers the compressed flow of air 20 to a number of combustor cans 25. The combustor cans 25 mix the compressed flow of air 20 with a pressurized flow of fuel 30 and ignite the mixture to create a flow of hot combustion gases 35. Although only a single combustor can 25 is shown, the gas turbine engine 10 may include any number of combustor cans 25 positioned in a circumferential array and the like. The flow of the hot combustion gases 35 is in turn delivered to a turbine 40. The flow of the hot combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, liquid fuels, and/or other types of fuels and blends thereof. The gas turbine engine 10 may be any one of a number of different gas turbine engines offered by General Electric Company of Schenectady, New York, including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

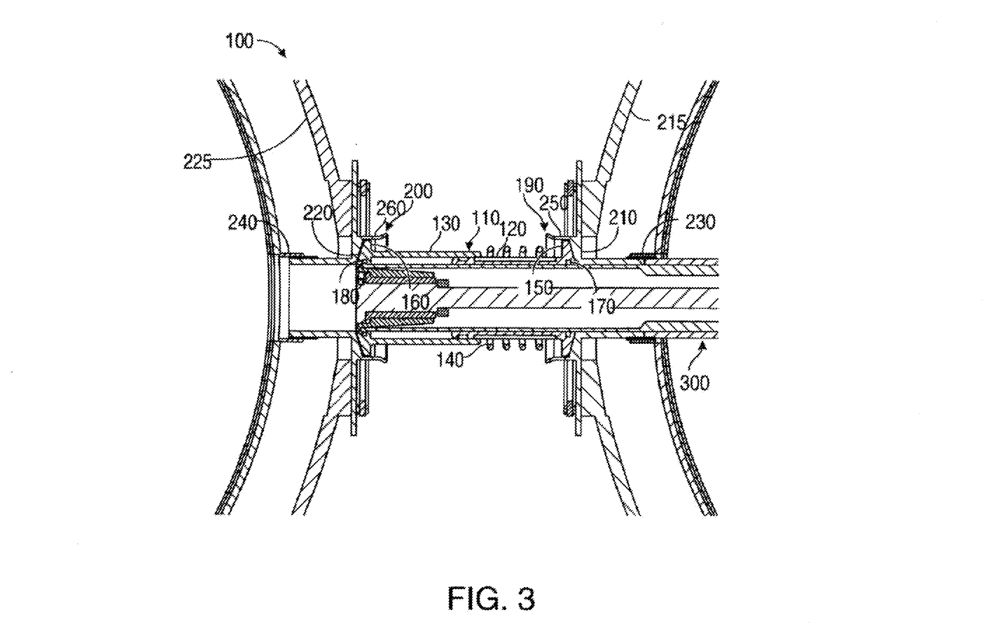

FIG. 2 shows a schematic diagram of an example of a combustor can 25 as may be used with the gas turbine engine 10 described above and elsewhere. The combustor can 25 may extend from an end cap 52 at a head end to a transition piece 54 at an aft end about the turbine 40. A number of fuel nozzles 56 may be positioned about the end cap 52 A liner 58 may extend from the fuel nozzles 56 towards the transition piece 54 and may define a combustion zone 60 therein. The liner 58 may be surrounded by a flow sleeve 62. The liner 58 and the flow sleeve 62 may define a flow path 64 therebetween for the flow of air 20 from the compressor 15 or otherwise. The combustor can 25 also may include a crossfire tube assembly 66. As described above, the crossfire tube assembly may extend between adjacent combustor cans 25. The combustor can 25 described herein is for the purpose of example only. Combustor cans 25 with other components and other configurations may be used herein.

FIG. 3 shows a cross fire tube installation/removal apparatus 100 with an example of a cross fire tube assembly 110 as may be described herein. As described above, each cross fire tube assembly 110 extends between two adjacent combustor cans 25. Any number of cross fire tube assemblies 110 may be used herein.

Generally described, the crossfire tube assembly 110 may have a pair of telescoping sleeves, a first sleeve 120 and a second sleeve 130. The first sleeve 120 and the second sleeve 130 may be sized for sliding engagement with one another. One or more springs 140 or other type of biasing elements may be in communication with the first sleeve 120 and the second sleeve 130. The spring 140 may be a compression spring and the like that circumferentially surrounds at least a portion of the first sleeve 120 and the second sleeve 130. The first sleeve 120 may have a first flange 150 at one end thereof and the second sleeve 130 may have a second flange 160 at the opposite end thereof. The first flange 150 may have a first groove 170 on an interior surface and the second flange 150 may have a similar second groove 180 thereon.

The crossfire tube assembly 110 further may include a pair of crossfire tube collars, a first crossfire tube collar 190 and a second crossfire tube collar 200. The first crossfire tube collar 190 extends through a first annular passage 210 through the liner 58 and the flow sleeve 62 of a first combustor can 215 and the second crossfire tube collar 200 extends through a second annular passage 220 the liner 58 and the flow sleeve 62 of an adjacent second combustor can 225. The first crossfire tube collar 190 may be sized for a friction fit and the like within a first liner collar 230 and the second crossfire tube collar 200 may be sized for a friction fit within a second liner collar 240. The first crossfire tube collar 190 may have a first collar flange 250 and the second crossfire tube collar 200 may have a second collar flange 260. The collar flanges 250, 260 may be sized to accommodate the sleeve flanges 150, 160. The size, shape, and configuration of the overall crossfire tube assembly 110 may vary. Other components and other configurations may be used herein.

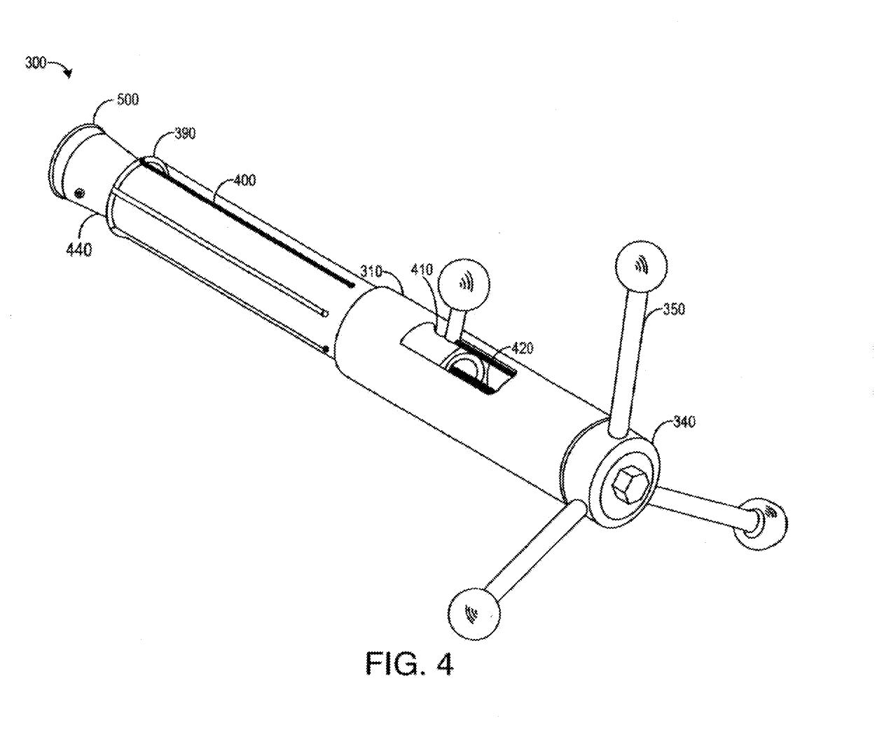

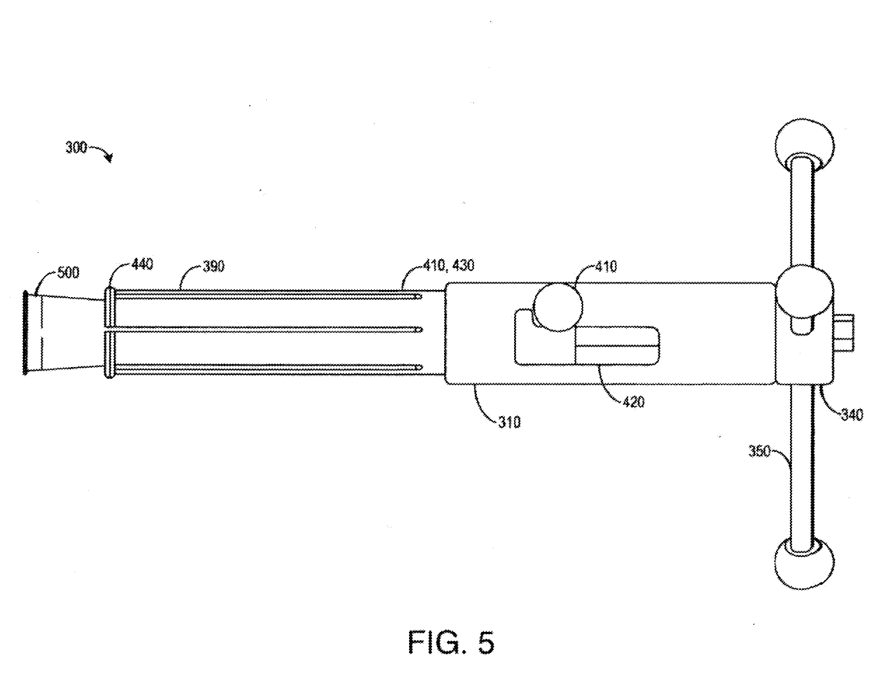

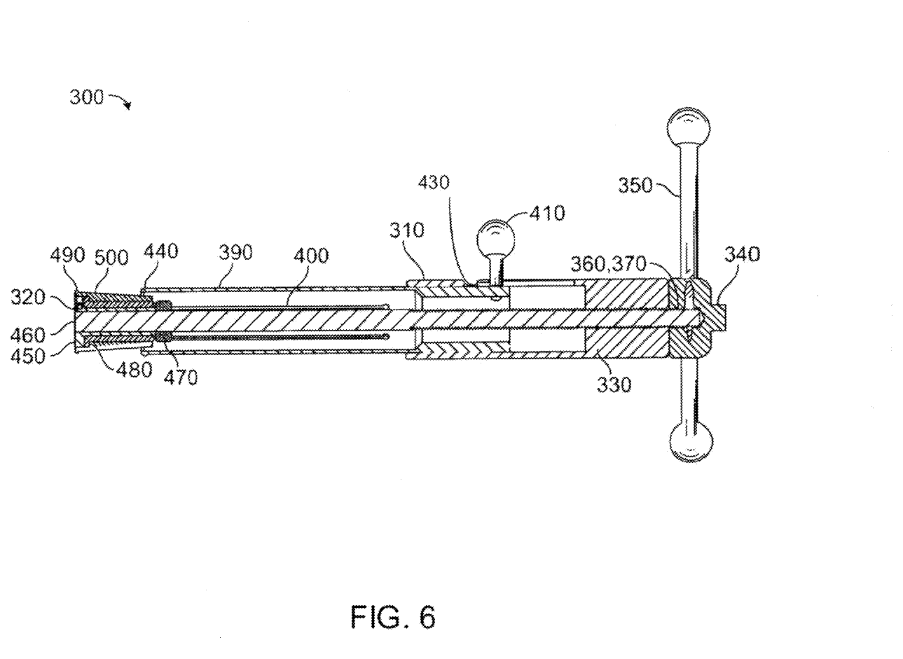

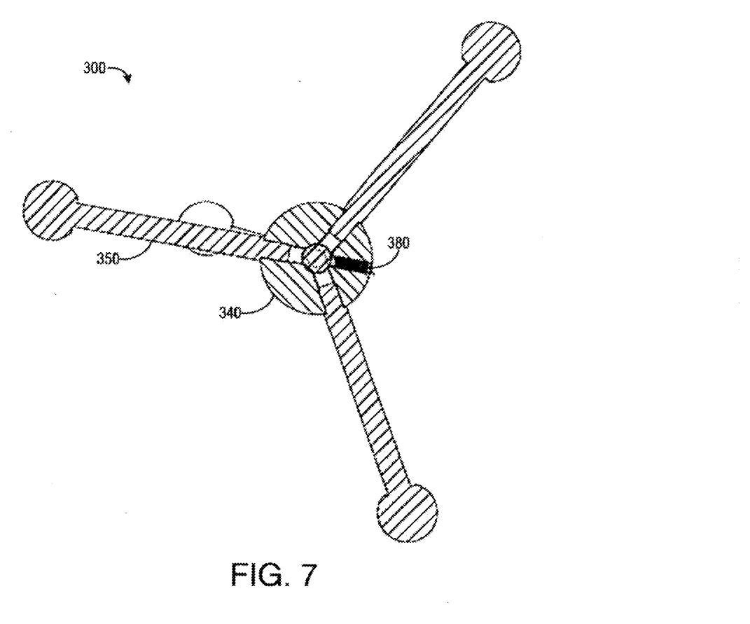

FIGS. 3-7 show an example of a crossfire tube tool 300 of the crossfire tube installation/removal apparatus 100. The crossfire tube tool 300 includes a reaction arm 310. The reaction arm 310 may be substantially tubular in shape and may be made out of steel or other types of substantially rigid materials. The reaction arm 310 may have a driving screw 320 extending therethrough. The driving screw 320 may be made out of steel or other types of substantially rigid materials. The driving screw 320 may have a number of driving screw threads 330 thereon. The driving screw 320 may have any suitable size, shape, or configuration.

The crossfire tube tool 300 also includes a holder 340 with a number of holder arms 350 positioned at one end of the reaction arm 310. The holder 340 may be made out of stainless steel or other types of substantially rigid materials. The holder 340 may have an internal driving screw aperture 360 therein. The driving screw aperture 360 may have a number of holder threads 370. The driving screw aperture 360 may be sized to accommodate the driving screw 320 therein in threaded engagement for movement therewith. A holder set screw 380 also may be used. The holder arms 350 may be sized and positioned to maneuver the driving screw 320 of the crossfire tube tool 300 as desired.

The crossfire tube tool 300 may have a tubular spring 390 positioned partially within and at the other end of the reaction arm 310. The tubular spring 390 may be substantially tubular in shape and may be made out of steel or other types of substantially rigid materials. The tubular spring 390 may have a number of spring slots 400 formed therein so as to give the tubular spring 390 an appropriate amount of compressibility. The size, shape, and configuration of the spring slots 400 may vary. The tubular spring 390 may be maneuverable within the reaction arm 310 via a locking knob 410 positioned within a locking knob aperture 420 in the reaction arm 310. The locking knob 410 may be made out of stainless steel or other types of substantially rigid materials. The locking knob aperture 420 may have a number of locking slots 430 formed therein so as to lock the locking knob 410 and the tubular spring 390 in place for insertion or removal of the crossfire tube assembly 110. The tubular spring 390 may have a spring flange 440 on the opposite end thereof. The spring flange 440 may be sized to engage with the grooves 170, 180 of the crossfire tube assembly 110 as described above.

The crossfire tube tool 300 may have a bearing journal 450 attached one the end of the driving screw 310. The bearing journal 450 may have a number of bearing journal threads 460 thereon for threaded engagement with the driving screw 310. A bearing journal set screw 470 also may be used. The bearing journal 450 may be made out of steel or other types of substantially rigid materials. A sleeve bearing 480 may surround the bearing journal 450. The sleeve bearing 480 may be made out of brass or other types of substantially rigid materials. The bearing journal 450 and the sleeve bearing 480 may be held in place on the driving screw 320 via a hex nut 490 or a similar type of closures. A cone end 500 and the like may enclose the bearing journal 450 and the sleeve bearing 480. The cone end 500 may be made of steel and similar types of substantially rigid materials. Other components and other configurations may be used herein.

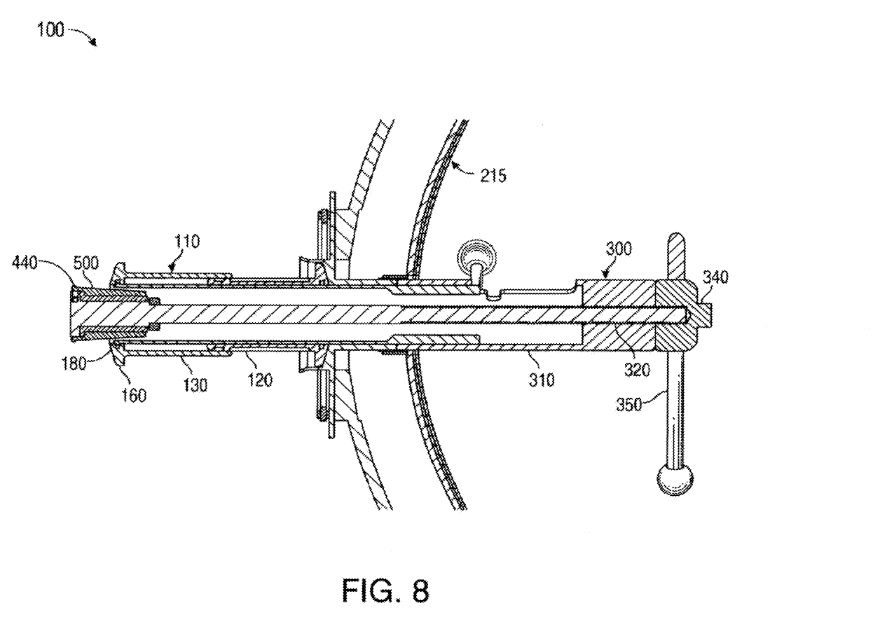

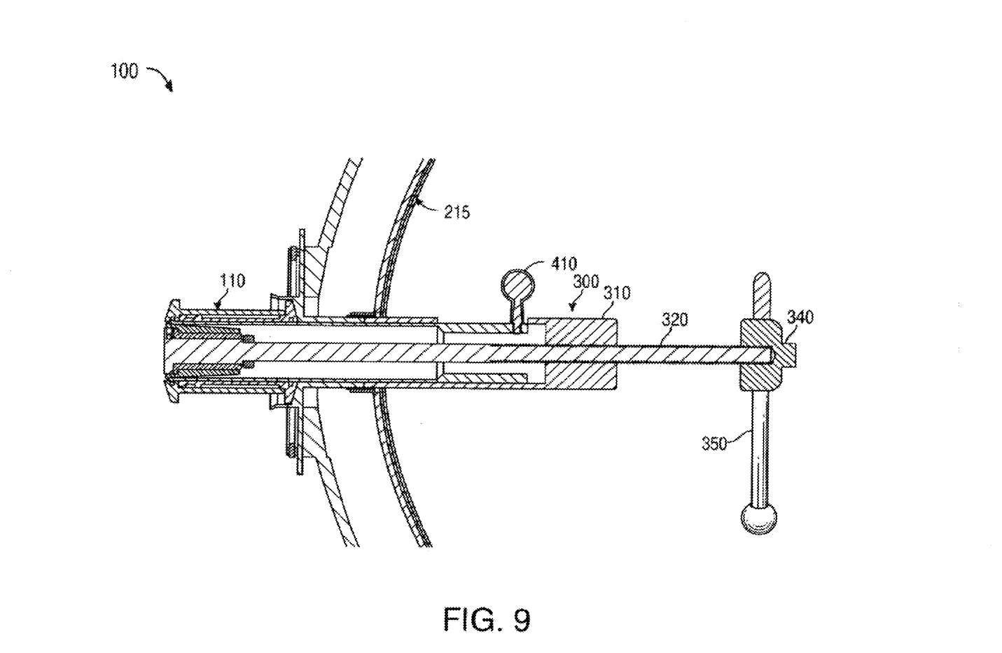

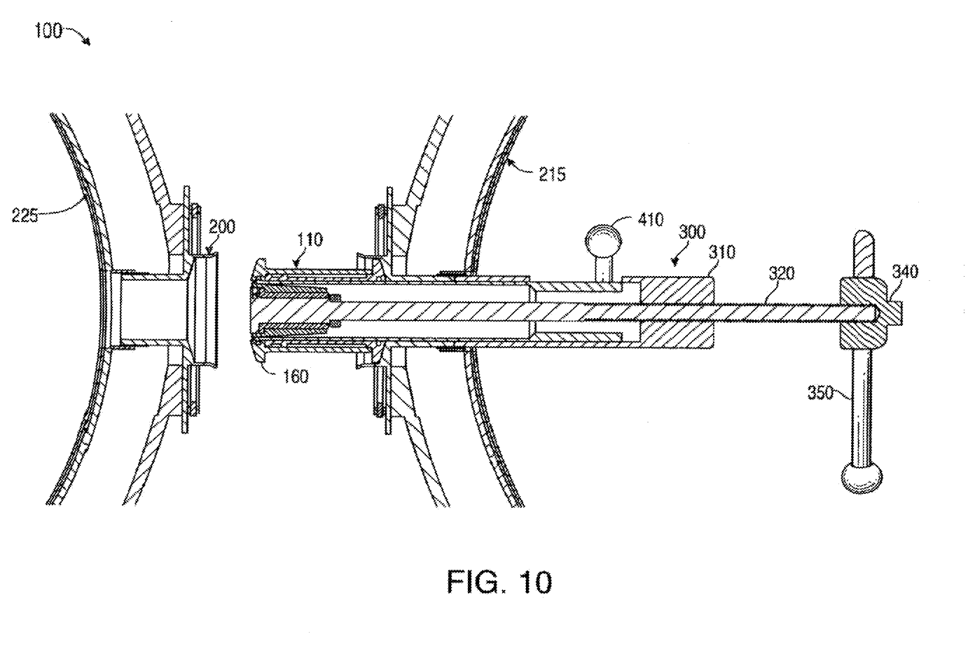

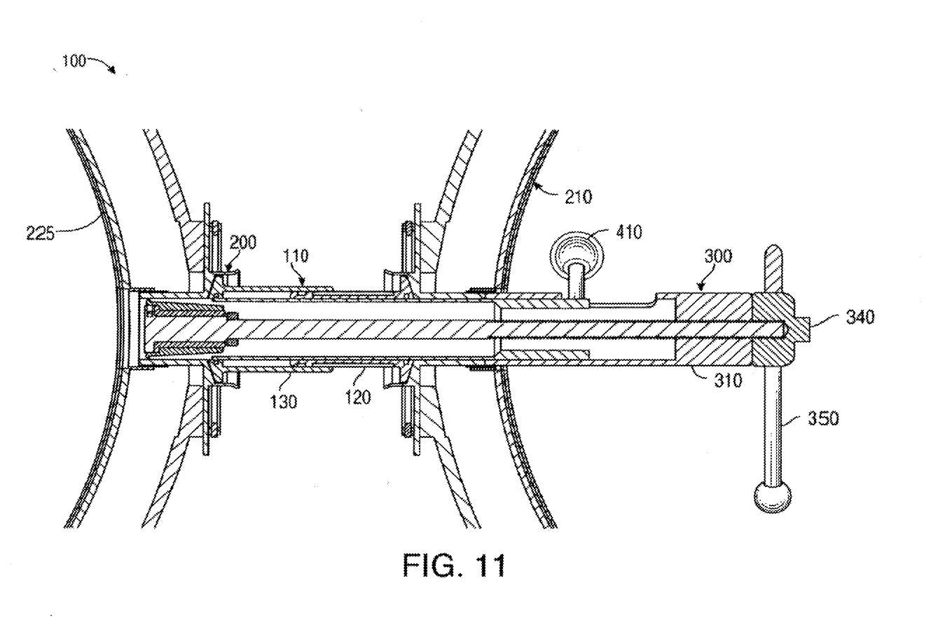

FIGS. 8-11 show the crossfire tube apparatus 100 in operation. In FIG. 8, the crossfire tube tool 300 may be inserted through the first annular passage 210 within the liner 58 and the flow sleeve 62 of the first combustion can 215. The crossflow tube assembly 110 then may be placed on the crossfire tube tool 300 between the two adjacent combustor cans 215, 225. In FIG. 9, the crossfire tube tool 300 may be compressed such that the spring flange 440 of the tubular spring 390 engages the second groove 180 in the second flange 160 of the second sleeve 130 of the crossfire tube assembly 110. The cone end 500 may be configured to expand the diameter of the tubular spring 390 to lock the spring flange 440 in place. In FIG. 10, the crossfire tube tool 300 may be further compressed via the driving screw 320 and the holder 340 so as to compress the crossfire tube assembly 110. In FIG. 11, the second collar 200 of the crossfire tube assembly 110 may be positioned within the second passage 220 of the second combustor can 225. The compression on the crossfire tool 300 then may be released so as to drive the second sleeve 130 of the crossfire tube assembly 110 into the second collar 200. The crossfire tube tool 300 then may be removed. Similarly, the crossfire tube assembly 110 may be removed in largely the opposite fashion. Other components and other configurations may be used herein.

The crossfire tube tool 300 thus may lock into place within the grooves 170, 180 of the crossfire tube assembly 110 for accurate placement given the use of the spring flange 440 and the cone end 500. Likewise, the tubular spring 390 may be mechanically compressed via the driving screw 320. The crossfire installation/removal apparatus 100 thus allows for the accurate and timely installation and removal of the crossfire tube assemblies 110.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A method of installing a cross fire tube assembly between a first combustor can and a second combustor can, comprising:
inserting a cross fire tube tool through a first passage in the first combustor can;
engaging a tube groove in the cross fire tube assembly with a spring flange of the cross fire tube tool;
compressing the cross fire tube tool with the cross fire tube assembly engaged;
positioning the cross fire tube assembly in a second passage in the second combustor can; and
releasing the cross fire tube tool.

2. The method of claim 1, wherein inserting the cross fire tube tool through the first passage comprises inserting the cross fire tube tool through the first passage within a liner and a flow sleeve of the first combustor can.

3. The method of claim 1, wherein engaging the tube groove comprises expanding a tubular spring of the cross fire tube tool so that the spring flange locks into the tube groove.

4. The method of claim 3, wherein expanding the tubular spring comprises advancing a cone end of the cross fire tube tool so as to expand a diameter of the tubular spring.

5. The method of claim 1, wherein compressing the cross fire tube tool comprises rotating a driving screw of the cross fire tube tool via a holder.

6. The method of claim 5, wherein rotating the driving screw via the holder comprises actuating a plurality of holder arms on the holder.

7. The method of claim 1, wherein positioning the cross fire tube assembly within the second passage comprises seating a second cross fire tube collar within a second liner collar of the second combustor can by a friction fit.

8. The method of claim 7, wherein seating the second cross fire tube collar comprises releasing compression on the cross fire tube tool so that a spring of the cross fire tube assembly drives the second cross fire tube collar into the second liner collar.

9. The method of claim 1, further comprising, prior to inserting the cross fire tube tool, locking a tubular spring of the cross fire tube tool in a retracted position within a reaction arm via a locking knob.

10. The method of claim 9, further comprising, after engaging the tube groove, releasing the locking knob from a locking knob aperture so as to permit the tubular spring to extend within the reaction arm.

11. The method of claim 1, wherein the cross fire tube assembly comprises a first sleeve and a second sleeve in telescoping engagement with one another and a bias acting between the first sleeve and the second sleeve, and wherein compressing the cross fire tube tool compresses the cross fire tube assembly against the bias.

12. The method of claim 1, wherein engaging the tube groove comprises engaging a first groove in a first flange of a first sleeve of the cross fire tube assembly with the spring flange.

13. The method of claim 12, further comprising, after releasing the cross fire tube tool, engaging a second groove in a second flange of a second sleeve of the cross fire tube assembly with the spring flange to verify seating of the cross fire tube assembly.

14. A method of removing a cross fire tube assembly from between a first combustor can and a second combustor can of a gas turbine engine, comprising:
inserting a cross fire tube tool through a first passage in the first combustor can;
engaging a tube groove of the cross fire tube assembly with a spring flange of the cross fire tube tool;
compressing the cross fire tube assembly via the cross fire tube tool so as to disengage a cross fire tube collar from a liner collar; and
withdrawing the cross fire tube assembly and the cross fire tube tool from the first passage.

15. A method of preparing a cross fire tube tool for installation of a cross fire tube assembly in a combustor of a gas turbine engine, comprising:
retracting a tubular spring within a reaction arm of the cross fire tube tool;
locking the tubular spring in the retracted position within the reaction arm via a locking knob engaged with a locking knob aperture;
inserting the cross fire tube tool through a passage in the combustor; and
releasing the locking knob so as to permit the spring flange of the tubular spring to engage a tube groove of the cross fire tube assembly.
